(19) United States
(12) Patent Application Publication
(10) Pub. No.: US 2010/0276951 A1
(43) Pub. Date: Nov. 4, 2010

(54) AUTOMOBILE PROTECTOR

(76) Inventors: Ronny Malina, New York, NY (US); Eric Malina, Nanuet, NY (US)

Correspondence Address: SONNABENDLAW, 600 PROSPECT AVE, BROOKLYN, NY, 11215, US

(21) Appl. No.: 12/432,812

(22) Filed: Apr. 30, 2009

(51) Int. Cl. B60R 19/44

(52) U.S. Cl. 293/142

(57) ABSTRACT

An automobile bumper protector device is provided that includes a plurality of impact absorbing members and a coupling component affixed to each impact absorbing member. The coupling component is configured to maintain each impact absorbing member at a spaced distance from one another. The coupling component defines a flexible hinge in the spaced distance region between adjacent impact absorbing members such that each impact absorbing member is movable relative to one another to conform to the surface portion of automobile when detachably affixed thereto.

### FIELD OF THE INVENTION

This invention relates to an automobile protection device and more particularly to a protection device for protecting the bumper of an automobile, especially the rear bumper.

### BACKGROUND OF THE INVENTION

Automobile bumpers are very easily damaged upon impact even at low impact velocities such as are encountered in the parking of vehicles. Automobiles are especially vulnerable when left at parking lots often because of the tightness of space and the desire to fit as many cars as possible in the lot. Typically, the automobiles, especially at the rear, are brought too closely into contact with the front of the next automobile. Likewise, automobiles are vulnerable when positioned in parallel parking spaces where the bumpers of adjacent cars are typically in close proximity to each other and often come in contact with one another when an automobile maneuvers to either enter or exit a parallel parking space.

The current vulnerability of today's automobile bumpers are actually attributable to the recent significant developments that have been made in the field of automobile body design. For instance, many automobile bodies now have “crumple zones” for absorbing a substantial portion of the kinetic energy of colliding vehicles in order to provide additional protection to passengers. Many automobile bodies are now composed of lightweight materials, e.g., aluminum composites, to improve fuel efficiency and to enhance the handling and performance of the vehicles. An unfortunate drawback of such developments, even though the bodies are safer, is that the bodies have also become somewhat fragile. Body damage may now result from light collisions, often requiring expensive repairs.

The bumpers of modern automobile bodies have similarly become more fragile, a result of changes to their configuration. Earlier bumpers were generally heavy metallic structures often with thick rubber outer layers for protecting automobile bodies from all light collisions, e.g., a collision between a parked automobile and an adjacent parking automobile. In contrast, modern bumpers are relatively lightweight and are largely non-metallic. A modern bumper may comprise an inner core of an expanded polystyrene thermoplastic foam material and a thin rubber and/or plastic outer shell layer.

Additional “improvements” have been made to modern automobile bumpers. Whereas earlier front and rear bumpers were typically clearly distinguishable from the respective front and rear regions of automobile bodies, modern bumpers are often less distinguishable therefrom because they are integrated into the overall body designs. Some modern bumpers even comprise internal structures housed within the envelope of the front and rear regions of automobile bodies. A dent or other deformation in such a bumper is now likely to affect the “lines” of the body, in turn giving the appearance of body damage to the vehicle (as opposed to the appearance of damage to only the bumper of an earlier vehicle).

In further contrast with the earlier bumpers having thick black rubber outer layers, the outer layers of modern bumpers are typically painted to match the overall color schemes of automobile bodies. Even a soft strike or scrape against a modern bumper can damage the paint thereon. As a result, the paint job of the overall vehicle may appear flawed. However, it is likely that the same soft strike would have been entirely absorbed by earlier bumpers without any damage thereto. Whereas a blemish on an earlier bumper was relatively inconspicuous, a blemish on a painted bumper is now more noticeable.

As mentioned above, an automobile is particularly susceptible to bumper damage while parking and, as often as not, while parked and left unattended in a parking lot. A parked automobile may be stricken by another vehicle which parks adjacent to it. Even light strikes may damage modern bumpers, whereas earlier bumpers would have been invulnerable to such strikes. For individuals who try to maintain their automobiles in immaculate condition, these strikes are very frustrating occurrences. Thus there is a need for a means of providing reliable protection to modern automobile bumpers that is convenient to use.

Earlier proposed protectors are disclosed in the prior art. U.S. Pat. No. 3,378,296 discloses a vehicle bumper cushion with hook members for clamping and securing the cushion to a bumper, which cushion remains attached to an automobile when it is driven. U.S. Pat. No. 5,618,073 to discloses a fabric or leather automobile bumper protector for shielding a rear bumper. This protection device, which remains attached to an automobile when it is driven, is held in place across the rear bumper by straps which are looped through specially configured external attachment handles affixed to each of the automobile's rear wheel wells. Thus the automobile requires modification, specifically the handles must be permanently mounted within the wheel wells, e.g., by the use of sheet metal screws. The location of the handles leaves little room for a user's fingers to manipulate the straps thereon.

There is, therefore, a need for a new protective device for the rear bumper of an automobile.

### SUMMARY OF THE INVENTION

This invention provides a temporary impact or crash absorber device attachable to an automobile bumper to absorb a low impact shock with another vehicle, typically encountered during a parking operation. The device of the instant invention may be portable, so that when attached, it allows the driver to hear and feel engagement with another vehicle before any scratches, dents, and other damage occurs on the surface of the bumper or of other parts of either car. Damage to both vehicles may thus minimized, if not eliminated.

The device of the instant invention may be readily attached to and removed from the trunk of virtually any automobile without requiring any modifications thereto. It may also be collapsed to a compact size so as to be easily stored in the trunk of an automobile.

The device of the instant invention may include a plurality of impact absorbing members and a coupling component affixed to each impact absorbing member. The coupling component may be configured to maintain each impact absorbing member in a spaced distance from one another. The coupling component may define a flexible hinge in the spaced distance region between adjacent impact absorbing members such that each impact absorbing member is movable relative to one another to conform to the surface portion of automobile when detachably affixed thereto. A supporting structure also may be provided that enables easy detachable engagement of the bumper protection device preferably to the trunk lid structure of an automobile.

### BRIEF DESCRIPTION OF THE DRAWINGS

The objects and features of the invention may be understood with reference to the following detailed description of an illustrative embodiment of the invention taken together with the accompanying drawings in which:

FIG. 1 is a perspective view of the present invention bumper protector device coupled to the rear portion of an automobile;

FIG. 2 is a partial perspective view of the backside of the bumper protector device depicted in FIG. 1;

FIG. 3 is a perspective view of the bumper protector device depicted in FIG. 1 shown in a folded and collapsed configuration for storage and transport;

FIG. 4 is a partial perspective view of a mounting strap extending from the bumper protector device depicted in FIG. 1;

FIG. 5 is a cross-sectional view the mounting strap taken along line 5-5 of FIG. 4;

FIG. 6 is a partial side planar view of the bumper protector device illustrating an alternative embodiment for coupling adjacent cushion members; and

FIG. 7 is a partial perspective view of the seamed connection between cushion members illustrated in FIG. 6.

### DETAILED DESCRIPTION

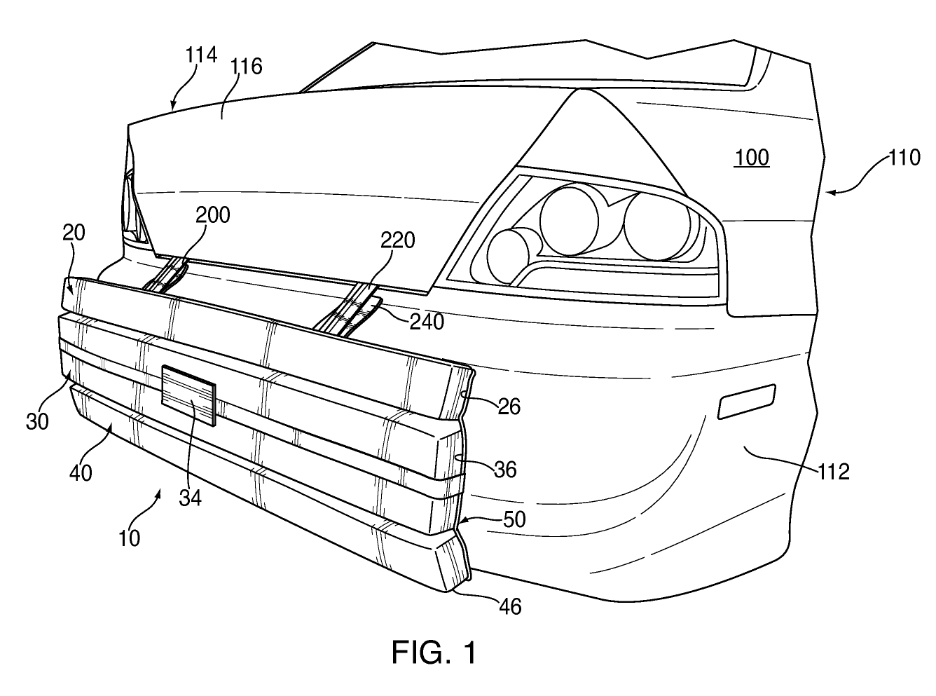

Turning now descriptively to the drawings, in which similar reference characters denote similar elements throughout the several views, FIG. 1 illustrates the bumper protector of the instant invention, designated generally by reference numeral 10 and shown coupled to the rear portion 110 of an automobile 100.

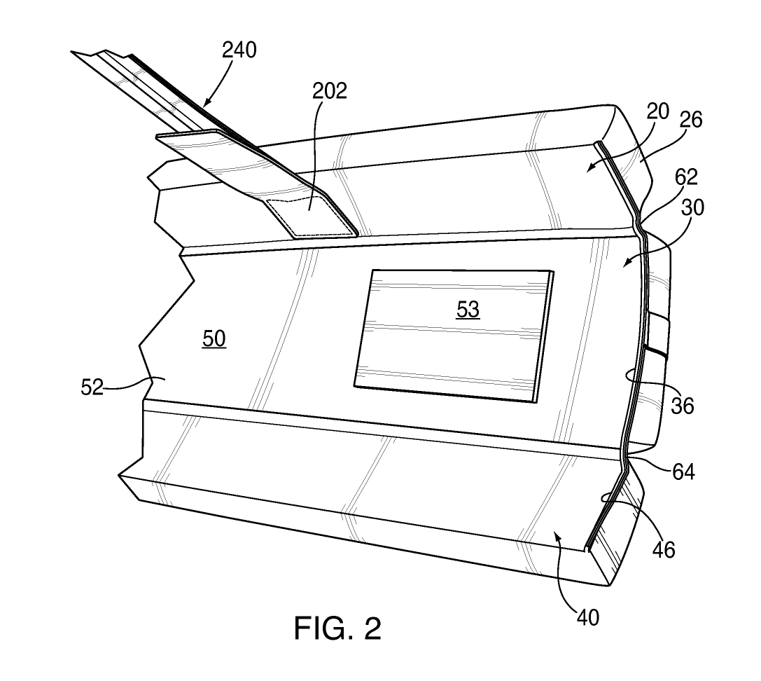

With reference to FIGS. 1 and 2, bumper protector 10 preferably includes three coupled cushion sections, namely a central cushion section 30 and two side cushion sections 20 and 40. In the embodiment shown, the central cushion section 30 has a larger surface area (i.e., larger width) relative to the side cushion sections 20, 40 with each side cushion 20, 40 having similar dimensions. Each cushion section 20, 30 and 40 is preferably formed of a deformable material which may consist of any impact absorbing cushioning material such as plastic foam, preferably styrofoam, polystyrene thermoplastic foam, and elastic material such as rubber or a rubbery polymer such as synthetic rubbers or nitrites used as cushioning materials. The material is preferably one that bounces back to its original configuration, but does not have to. Each block of the deformable material forming each cushion section 20, 30 and 40 may also be encased within a flexible fabric type of material formed of cloth, vinyl, plastic and the like.

It is to be appreciated that even though bumper protector 10 is being described with reference to three coupled cushion sections 20, 30 and 40, the bumper protector of the instant invention is not to be understood to be limited to only three cushion sections. Rather, it is to be understood that bumper protector 10 may include any plurality of cushion sections wherein the coupling of adjacent cushion sections is preferably to be the same as described below with reference to cushion sections 20, 30 and 40.

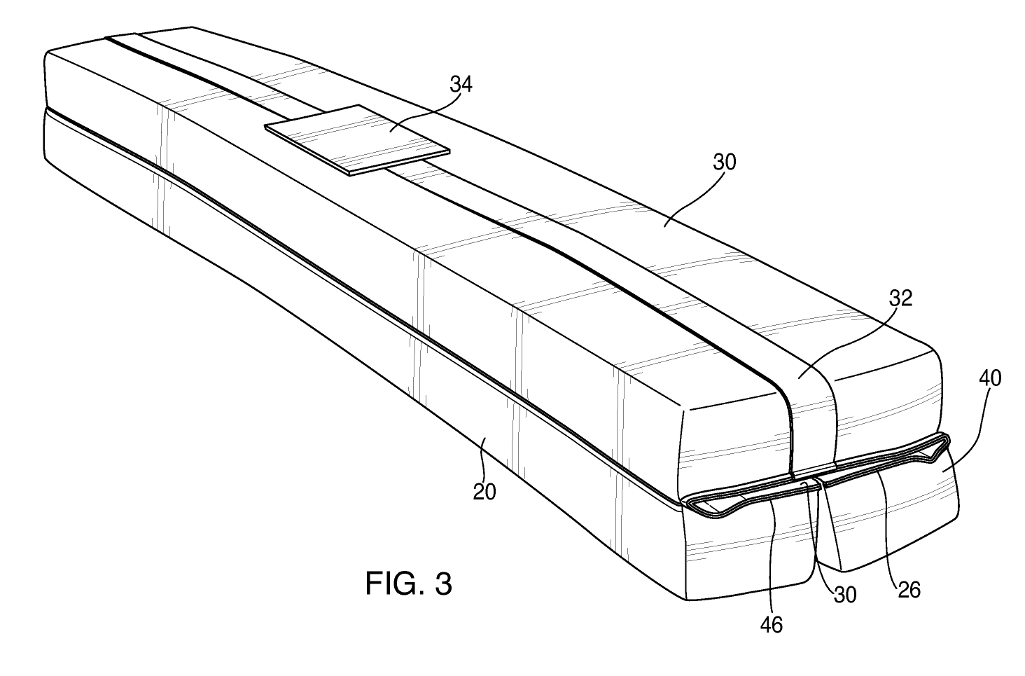

As will also be discussed further below, the side cushion sections 20, 40 are flexibly coupled to the central cushion section 30 for enabling the angle between each side cushion section 20 and 40 and the central cushion section 30 to be adjusted, thus permitting the shape of the overall body portion of the bumper protector 10 to conform to the shape/contour of the rear bumper 112 of the automobile 100 which bumper protector 10 seeks to protect, as shown in FIG. 1. Additionally, the flexible coupling of the central cushion section 30 to the side cushion sections 20, 40 also permit the folding of the bumper protector 10 into a compact, block like structure as shown in FIG. 3 permitting ease of storage, for example, in the trunk portion 114 of an automobile 100.

As best shown in FIGS. 1 and 3, the front surface portion of central cushion section 30 is preferably provided with a strip of reflective tape 32, or like material, positioned along it's center portion extending in a longitudinal direction thereof. Reflective tape 32 is functional to reflect light back to an oncoming car to provide notice, and possibly warn of close proximity, of an oncoming automobile. It is also to be understood that the remaining cushion sections (20 and 40) may likewise be provided with a strip of reflective tape or like material. As is also shown, additional material 34 may be provided on the outer surface portion of central cushion member 30 (or the other cushion section members 20 and 40) providing additional reflectivity capabilities or to provide indicia thereon for advertisement or direction purposes.

With continued reference to FIGS. 1-3, each elongate cushion section 20, 30 and 40 has its respective back portion 26, 36 and 46 affixed to a unitary and flexible backing pad 50 wherein each elongate cushion section 20, 30 and 40 is spaced apart while extending parallel relative to one another. The flexible backing pad 50 has opposing front 54 and back 52 portions preferably formed from flexible material such as cloth, leather, vinyl, plastic and the like. Backing pad 50 is dimensioned to accommodate, and adhere to on its back portion 52, the back portion 26, 36 and 46 of each cushion section 20, 30 and 40. As best shown in FIG. 2, side cushion sections 20 and 40 are spaced apart from central cushion member 30 a predefined distance thereby proving a flexible hinge 62, 64 on the backing pad 50 between the central cushion section 30 and each side cushion section 20, 40. Thus each flexible hinge 62, 64 is defined by an open space on the front portion 54 of the backing pad 50 present between adjacent cushion section members 20, 30 and 40. Preferably the dimension of each flexible hinge 62, 64 is the same (thus each side cushion section 20, 40 extends equally distant from the central cushion section 30), but it is to be understood that the dimension of each hinge 62, 64 may also differ from one another enabling a bottom cushion section 40 to extend further from central cushion section 30 relative to a top cushion section member 20 when the width of the hinge 64 between the bottom 40 and central cushion section 30 is greater than the width of the hinge 62 between the top 20 and central cushion section 30. An advantage of this configuration is to provide protection for a bumper having a bottom portion that is larger in dimension relative to its top portion.

As also shown in FIG. 2, strips or patches of non-skid material 53 may be provided on the backside 52 of the backing pad 50 for preventing movement of bumper protector 10 relative to the rear bumper 112 when bumper protector 10 is affixed thereto.

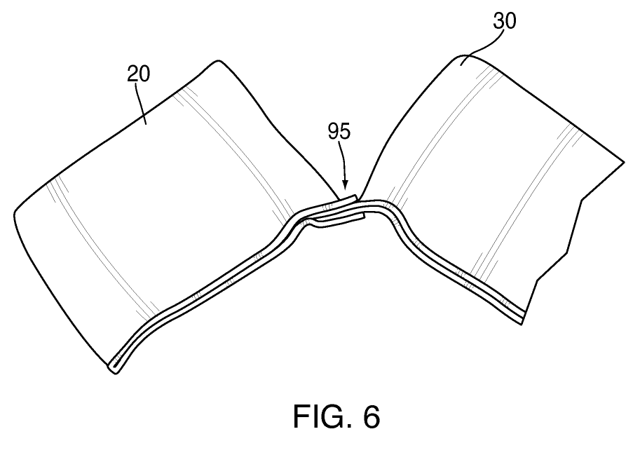

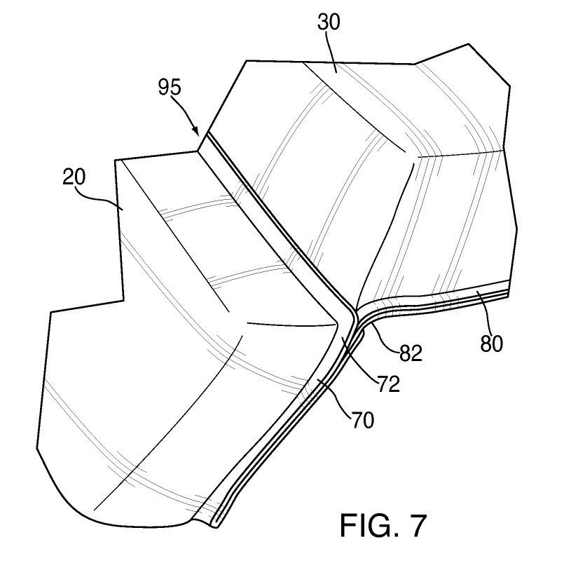

With reference now to FIGS. 6 and 7, an alternative embodiment to the unitary backing pad 50 discussed above will now be described. In this embodiment, each cushion section 20, 30 and 40 is affixed to a separate backing pad, wherein each backing pad is preferably dimensioned to have a width and length slightly greater than the width and length of the cushion section adhered thereto. As shown in FIG. 6, the section members 20 and 30 are respectively adhered to backing pads 70 and 80. Each separate backing pad 70, 80 is preferably formed from overlapping strips of material, which material preferably is formed from a flexible material such as cloth, leather, vinyl, plastic and the like.

With reference to side cushion section 20 and central cushion section 30, each aforesaid cushion section is coupled to one another via a flexible hinge formed by the coupling of it's respective separate backing pads 70, 80 to one another. In particular, each backing pad 70, 80 has an end point 72, 82 extending from its respective cushion section 20, 30 configured to couple with one another to form a flexible hinge 95 between adjacent cushion sections 20, 30. It is to be understood the functionality of this flexible hinge 95 is preferably the same as the functionality of the flexible hinge 62, 64 described above with respect to FIGS. 1-3. As shown in FIGS. 6 and 7, the end point 72 of the backing pad 70 for side cushion section 20 has its overlapping material separated such that the end point 82 of the backing pad 80 for center cushion 30 is fixedly mated between the separated end points 72 of the backing pad 20 for side cushion section 20. The end points 72, 82 may be fixedly mated to one another through any known fixation means, including gluing, melding, sewing, etc.

Additionally, it is to be understood that the end points 72, 82 may be detachably fixed to one another through means such hook-and-loop fabric (e.g., Velcro brand material), button arrangements, clasps, or the like. It is noted an advantage of this configuration is that additional bumper cushion sections may be added as needed (e.g., for a large automobile bumper, when used for a boat, or for other protective purposes) and/or the order of the cushion sections can be varied. For instance, the larger central cushion 30 can be positioned on the top or bottom of the bumper protector 10 as required.

With reference now to FIGS. 1, 2, 4 and 5, the mechanism for detachably coupling the bumper protector 10 to the rear portion 110 of an automobile 100 to protect it's rear bumper 112 will now be described. Enabling this coupling are first and second mounting straps 200, 220 each having a proximal end 202 fixed to a side cushion section 20. Each mounting strap 200, 220 also has an opposing distal end dimensioned and configured to extend into a car trunk portion 114 when bumper protector 10 is coupled to an automobile 100, as discussed below.

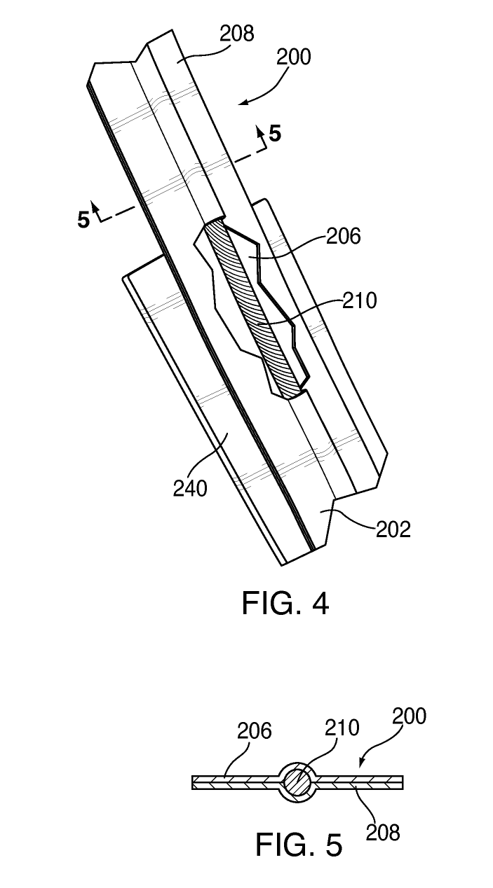

As best shown in FIGS. 4 and 5, each mounting strap 200, 220 is preferably formed of overlapping portions of material 206, 208 each preferably formed of material strong enough to handle an impact by another automobile, such as, leather, canvas, fabric, vinyl or other plastic and the like. To provide additional reinforcement and coupling properties, each mounting strap 200, 220 includes an enlarged reinforcing core 210 preferably extending through it's entire length and juxtaposed between it's overlapping strap portions 206, 208. The reinforcing core 210 can be formed of braided, or unbraided material, such as metal, twine, plastic or the like and preferably having a circumferential diameter.

As best shown in FIGS. 1, 2 and 4, each mounting strap 200, 220 is also provided with a protective strip 240 fixed to the outer portion of it's proximal end portion 202. Each protective strip 240 is formed of a material (such as cloth, leather, vinyl or plastic and the like) to protect against scratching or other abrasions that may occur on the rear bumper 112 of an automobile 100 when the bumper protector 10 is fitted thereto. Each protective strip 240 is preferably dimensioned to have a width greater than that of the mounting strap 200, 220 it is affixed to and has a length that may, or may not, extend into the trunk portion of the 114 of automobile 110 when bumper protector 10 is coupled thereto. For instance, as shown in FIG. 1, each protective strip 240 is dimensioned to have length which does not extend into the trunk portion 114 of automobile 110 when bumper protector 10 is coupled thereto.

With reference now to FIG. 1 and with the structure of bumper protector 10 being described above, its method of use will now be discussed. When a user desires to fit bumper protector 10 to the rear portion 110 of their automobile 100, the user preferably opens the trunk lid 116 to remove bumper protector 10 preferably stored within the trunk portion 114 of automobile 100. The user next preferably unfolds the bumper protector 10 from its storage configuration shown in FIG. 3 to it's unfolded configuration shown in FIG. 1. The user then positions the bumper protector 10 to cover the desired portion of the rear bumper 10 while causing each mounting strap 200, 220 to extend into the interior portion of the automobile's trunk 114. Next, the user closes the trunk lid 116 causing each mounting strap 200, 220 to be secured, and friction fitted against the trunk lid 116 and the inner surface of the trunk portion 114 to which the trunk lid 116 secures to. It is noted each reinforcing core 150 provided in each mounting strap 200, 220 also effectively increases the thickness of each mounting strap 220, 220 thus enabling a more secure friction fit when the trunk lid 116 is in its closed position.

To remove the bumper protector 10 from the rear portion 110 of the automobile 100, the user opens the trunk lid 116 thus releasing the friction fit between the trunk lid 116 and the mounting straps 200, 220 whereafter the user removes the mounting straps 200, 220 from the inner trunk portion 114. The user can then fold bumper protector 10 to it's folded configuration shown in FIG. 3 to preferably be stored within the trunk portion 114 of the automobile 100.

While preferred embodiments of the bumper protector 10 of the instant invention have been disclosed for illustrative purposes, those who are skilled in the art will appreciate that various modifications, additions and substitutions are possible, without departing from the scope and spirit of the bumper protector as set forth in the accompanying drawings.

What is claimed is:

1. A protector device for protecting a portion of an automobile from an impact comprising:
a plurality of impact absorbing members;
a coupling component affixed to each said impact absorbing member, said coupling component configured to maintain each said impact absorbing member in a spaced distance from one another, said coupling component defining a flexible hinge in each said spaced distance between adjacent said impact absorbing members such that each said impact absorbing member is movable relative to one another to conform to the surface portion of automobile when detachably affixed thereto.

2. A protector device as recited in claim 1 wherein each said impact absorbing member has a rectangular configuration.

3. A protector device as recited in claim 1 wherein said plurality of impact absorbing members include a central cushion member and first and second side cushion members wherein each said first and second side members are of the same size and said central cushion member is of a greater size than said first and second cushion members.

4. A protector device as recited in claim 3 wherein each said impact absorbing member is positioned on said coupling component such that said central cushion member is positioned intermediate said first and second side cushion members.

5. A protector device as recited in claim 4 wherein each said flexible hinge enables each first and second side cushion member to be folded atop said central cushion member.

6. A protector device as recited in claim 1 further including a supporting structure configured for detachable engagement to said automobile and for supporting said impact absorbing members against a portion of an automobile to be protected from an impact.

7. A protector device as recited in claim 6 wherein said supporting structure includes first and second elongate supporting straps each having a proximal end connected to one of said plurality of impact absorbing members and a distal end portion configured to detachable engage said automobile.

8. A protector device as recited in claim 7 wherein said first and second elongate supporting straps are each provided with an elongate core member increasing the surface area portion of each first and second elongate supporting straps to facilitate said detachable engagement of said protector device with said automobile when each said first and second elongate supporting straps are friction fitted against a portion of said automobile.

9. A protector device as recited in claim 1 wherein said coupling component is configured as a unitary piece of material.

10. A protector device as recited in claim 1 wherein said coupling component includes a plurality of separate coupling components each including overlapping material members with one of said overlapping materials affixed to a respective said impact absorbing member.

11. A protector device as recited in claim 10, wherein each of said plurality of material members for each said separate coupling component forms an end seam extending outwardly from it's respective affixed impact absorbing member wherein a said flexible hinge is formed by interconnection of adjacent end seams between adjacent said impact absorbing members.

12. A protector device as recited in claim 11, wherein said interconnection of adjacent end seams are detachable relative to one another.

13. A bumper protector device for protecting a rear bumper of said automobile, said protector device comprising:
a plurality of elongate impact absorbing members each defining a longitudinal axis;
a coupling component affixed to each said impact absorbing member, said coupling component configured to maintain each said impact absorbing member in a spaced distance from one another wherein the longitudinal axis of each said elongate impact absorbing member extends parallel relative to one another;
a flexible hinge defined on said coupling component in said spaced distance between each said impact absorbing member such that each said impact absorbing member is movable relative to one another to conform to the rear bumper of an automobile when detachably engaged thereto; and
a supporting structure configured for detachable engagement with a trunk lid of said automobile for supporting said impact absorbing components against said rear bumper of said automobile.

14. A bumper protector device as recited in claim 13 wherein said supporting structure includes first and second elongate supporting straps each having a proximal end connected to a top most said impact absorbing member relative to said rear bumper and a distal end portion configured to detachable engage with said trunk lid of said automobile.

15. A bumper protector device as recited in claim 14 wherein said first and second elongate supporting straps are each provided with an elongate core member increasing the surface area portion of each first and second elongate supporting strap to facilitate said detachable engagement of said bumper protector device with said automobile when each said first and second elongate supporting straps are friction fitted against said trunk lid.

16. A bumper protector device as recited in claim 13 wherein said plurality of impact absorbing members include a central cushion section and first and second side cushion sections wherein each said first and second side cushion sections are of the same size and the central cushion section is of a greater size than said first and second cushion sections and said central cushion section is positioned intermediate said first and second side cushion sections on said coupling device.

17. A bumper protector device as recited in claim 13 wherein said coupling component is configured as a unitary piece of material.

18. A bumper protector device as recited in claim 17 wherein said coupling component includes a plurality of separate coupling components each including overlapping materials members with one of said overlapping materials affixed to a respective said impact absorbing member wherein each of said separate coupling component forms an end seam extending outwardly from it's respective affixed impact absorbing member wherein a said flexible hinge is formed by interconnection of adjacent end seams between adjacent said impact absorbing members.

19. A bumper protector device for detachable engagement with a trunk lid of an automobile for protecting a rear bumper of said automobile, said protector device comprising:
first and second impact absorbing members each having a longitudinal axis;
a central impact absorbing member having a longitudinal axis and a surface area greater than each of said first and second impact absorbing members;
a coupling component affixed to each said impact absorbing member wherein said central impact absorbing member is positioned a spaced distance between said first and second impact absorbing members such that said longitudinal axis of each said impact absorbing member are parallel to each other;
a flexible hinge defined on said coupling component in said spaced region between each said impact absorbing member such that each said impact absorbing member is movably relative to one another to conform to the rear bumper of an automobile when detachably engaged thereto; and
first and second elongate supporting straps each having a proximal end connected to a first or second impact absorbing member and a distal end portion configured to detachably engage against said trunk lid of said automobile for supporting said impact absorbing members against said rear bumper of said automobile wherein said first and second elongate supporting straps are each provided with an elongate core member increasing the surface area portion of each first and second elongate supporting straps to facilitate a friction fit with said trunk lid.

20. A protector device as recited in claim 19 wherein said coupling component includes a plurality of separate coupling components each including overlapping materials members with one of said overlapping materials affixed to a respective said impact absorbing member wherein each of said separate coupling component forms an end seam extending outwardly from it's respective affixed impact absorbing member wherein a said flexible hinge is formed by interconnection of adjacent end seams between adjacent said impact absorbing members.
